(19) United States
(12) Patent Application Publication
(10) Pub. No.: US 2019/0087876 A1
(43) Pub. Date: Mar. 21, 2019

(54) User Engagement Display System

(71) Applicant: Anthony M. Jones, Petaluma, CA (US)

(72) Inventor: Anthony M. Jones, Petaluma, CA (US)

(21) Appl. No.: 16/195,165

(22) Filed: Nov. 19, 2018

Related U.S. Application Data
(63) Continuation-in-part of application No. 15/249,004, filed on Aug. 26, 2016.
Application No. 15/249,004 is a continuation-in-part of application No. 29/523,259, filed on Apr. 8, 2015, now Pat. No. D768167.

(51) Int. Cl. G06Q 30/02; G06F 3/0481; G06F 16/958; G06F 16/9535; G06F 3/0484

(52) U.S. Cl. CPC G06Q 30/0282; G06F 3/04817; G06F 3/04847; G06F 16/9535; G06F 16/958

(57) ABSTRACT

Disclosed embodiments include a consumer display system that may include the use of a main gauge, sometimes resembling a digital gasoline gauge of a vehicle, such that the main gauge displays an analog and/or digital value to comport with an overall score derived from user input into a plurality of categories.

### RELATED PATENT APPLICATION AND INCORPORATION BY REFERENCE

This is a utility application based upon and is a continuation in part of U.S. patent application Ser. No. 15/249,004 filed on or about Aug. 26, 2018 which is a continuation in part of design patent application 29/523,259 filed on Apr. 8, 2015. On or about Oct. 4, 2016 the design patent application was issued as design patent D768,167. These related applications are incorporated herein by reference and made a part of this application. If any conflict arises between the disclosure of the invention in this utility application and that in the related applications, the disclosure in this utility application shall govern. Moreover, the inventor(s) incorporate herein by reference any and all patents, patent applications, and other documents hard copy or electronic, cited or referred to in this application.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

### (1) Field of the Invention

The invention generally relates to display systems. More particularly, the invention relates to the use of display systems to artfully report and display user input in a multitude of categories.

### BRIEF SUMMARY OF THE INVENTION

The present invention overcomes shortfalls in the related art by presenting an unobvious and unique combination, configuration and use of display systems that may be applied to existing platforms. The disclosed displays and display systems display an overall metric or score in response to a consumer's input to a plurality of data categories. The disclosed embodiments artfully induce consumers to enter detailed opinions on content such that the entry of such opinion information is neither burdensome nor time consuming. The configuration of the disclosed display systems provides an engaging experience, entertainment or distraction so as to encourage and enable data input by consumers.

By use of the disclosed display systems, data may be collected and used to suggest consumer content that comports to a consumer's observed preferences.

By use of the disclosed display systems, data may be collected and used to populate ancillary display systems and/or digital ecosystems wherein consumers may view input from individuals as well as aggregated data sumations. Such ancillary display systems may take the form of social media sites or specific sites tailored to accept and display input acquired from the disclosed systems.

Disclosed embodiments include a consumer display system that may include the use of a main gauge, sometimes resembling a digital gasoline gauge of a vehicle, such that the main gauge displays an analog and/or digital value to comport with an overall score derived from user input into a plurality of categories. For example, an overall score or gas score may range from E for empty and F for full and may be displayed in a simulated analog format taking the form of a semi-circle. The overall score may also be displayed in a digital format with the digital score presented within the lower center section of the semi-circle or arc. A plurality of specific category scores may be displayed both numerically with a digital score and more graphically by use of horizontal slider display.

A consumer display system may further include a horizontal matrix display that may include a plurality of horizontal slider displays that show a value by the filling of the slider. A slider may take the form of a horizontally disposed bubble or hollow core with the bubble filled to reflect a score. For example, a horizontal matrix display subsystem may comprise a plurality of horizontally stacked horizontal bubbles, with each horizontal bubble aligned with a data descriptor and a digital score. One row or one line of an embodiment may include a horizontal bubble, filled to reflect a category, a specific score, a category or data type descriptor, such as originality, wow factor, appeal and impact and a numeric or digital representation of the score, such as 89%.

Disclosed embodiments include the use of platform display systems that may include user comment areas that include an area for user comment at or near an arc or horizontal matrix areas. Platform display systems may further include a top header section describing a scored media presentation, depicting an arc or semi-circle display and displaying a high scoring data category. A platform display system may further include a footer section to display third party user comments. Platform display systems may be hosted or operated by social media sites and other third party platforms.

Disclosed embodiments include the use of a master display system which may include the displays described above and additional displays showing content and a user interface to play the content. Master display systems may be hosted by owners or operators of the disclosed systems.

The disclosed embodiments overcome shortfalls in the related art by providing display systems such as consumer display systems, platform display systems and master display systems such that user input is easily collected and then displayed upon a plethora of formats and digital environments.

The disclosed embodiments are not a mere abstract idea, but take tangle form by the physically illustrated and disclosed interfaces in the drawings.

### BRIEF DESCRIPTION OF THE DRAWINGS

FIG. 1 is a plan view of a consumer display system

FIG. 2 is a plan view of a consumer display system

FIG. 3 is a plan view of a consumer display system

FIG. 4 is a plan view of a consumer display system

FIG. 5 is a plan view of an arc or semi-circle gauge

FIG. 6 is a plan view of a consumer display system

FIG. 7 is a plan view of a platform display system

FIG. 8 is a plan view of a master display system

### REFERENCE NUMERALS IN THE DRAWINGS

100 a consumer display system in general
110 a semi-circle or arc display system
115 semi-circle or arc element of an arc display system 110
116 void area defined within an arc element 115
117 inwardly disposed reference notch attached to an arc 110
118 an end notch disposed at either end of an arc 110
120 pivoting pointer, disposed within an arc 110
121 pointer section of a pivoting pointer 120
123 pivot section of a pivoting pointer 120
125 numeric value of arc display
127 logo display area
130 activation interface
140 horizontal matrix display system
150 a horizontal display area within a horizontal matrix display system 140
152 a filled section of a horizontal display area 150
154 an empty section of a horizontal display area 150
156 data descriptor of horizontal display 150
158 numeric value of a horizontal display area 150
160 circular push button interface
200 platform display system
210 header section of platform display system
212 content identifier information within header section
215 mid page area of platform display system 200
220 gauge and comment section within a platform display system
223 user icon or picture of user
230 footer section of platform display system
232 descriptor information of third party inputs
235 third party input
237 icon or picture of a third party
300 master display system
310 operator logo area
312 stage descriptor
314 my friends descriptor
316 panel descriptor
318 search input interface
320 mail icon
322 user identifier icon
324 refresh icon
326 descriptor of date of posting and identification of poster
328 follow interface
330 more details interface
340 hollow core arc display system
342 fill area within a hollow core 340
344 empty void within a hollow core 340
350 content display and content control
360 descriptor of number of reviewers
362 descriptor of numeric value of favorited ratings
364 descriptor of numeric value of comments

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

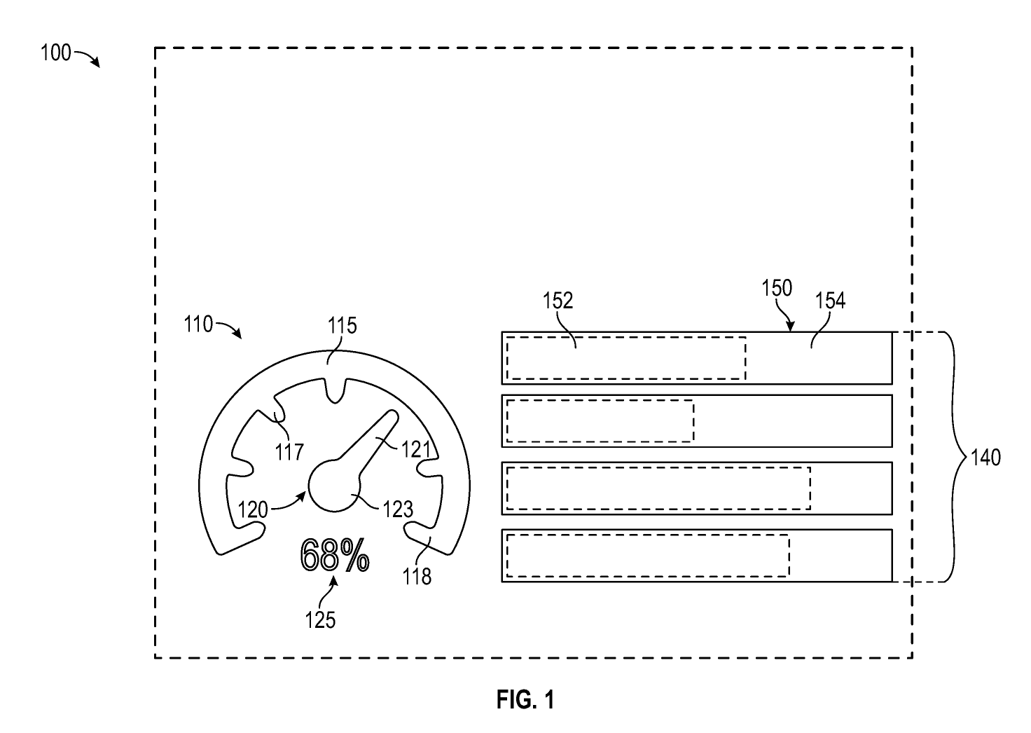

Referring to FIG. 1, a consumer display system 100 in general is shown and may include a semi-circle or arc display system 110 which may comprise a semi-circle or arc element 115, with the arc element comprising a plurality of inwardly disposed reference notches 117. The ends of the arc element 115 may comprise end notches 118.

A pivoting pointer 120 may be disposed within the center of the arc element 115, and the pivoting pointer may comprise a pivot section 123 attached to a pointer section 121. The pointer section may point to an arc element section to reflect an overall score. An overall score other score may be disposed under the pivoting pointer and may take the form of a numeric value 125. In FIG. 1, the displayed numeric value is 68%.

A consumer display system 100 and other systems disclosed herein may include a horizontal matrix display system or subsystem 140 which may comprise a plurality of horizontal display areas 150. A horizontal display area 150 may comprise a filled section 152 to comport with a numeric value assigned to the horizontal display area. A horizontal display area 150 may further comprise an empty section 154, not consumed or filled by a filled section 152.

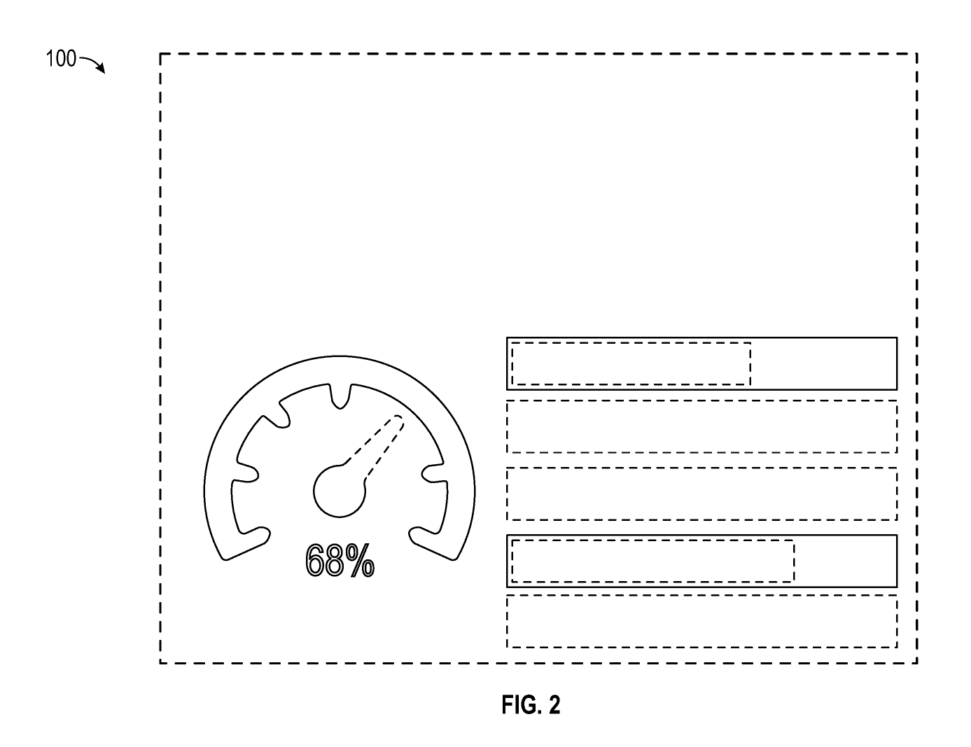

Referring to FIG. 2, a further representation of a consumer display system 100 is illustrated.

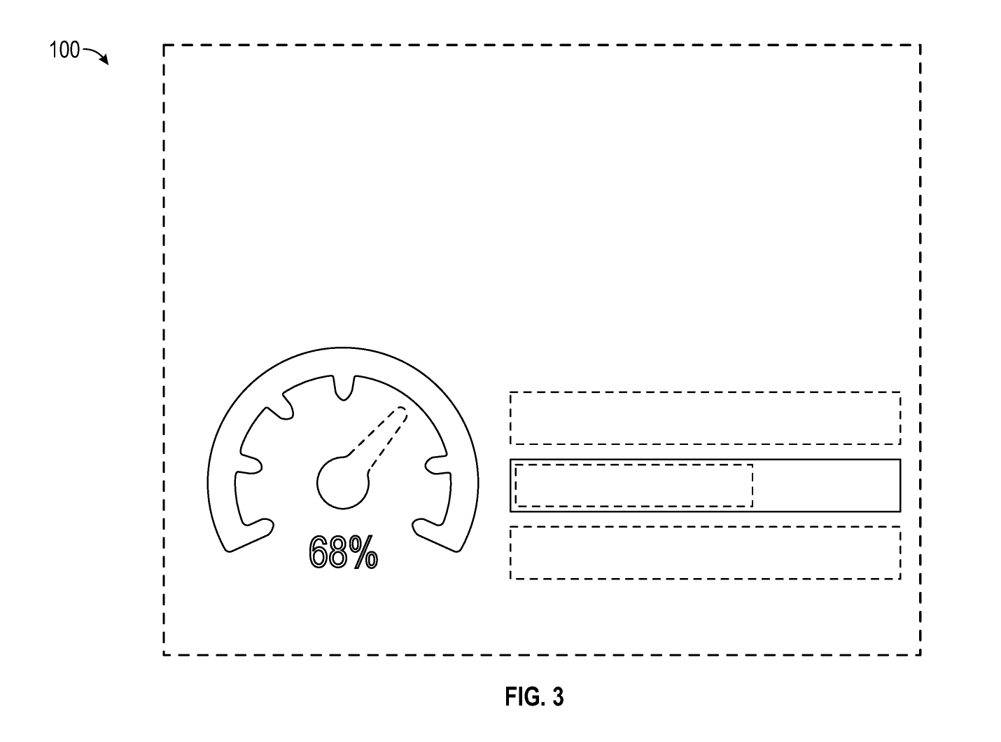

Referring to FIG. 3, a further representation of a consumer display system 100 is illustrated.

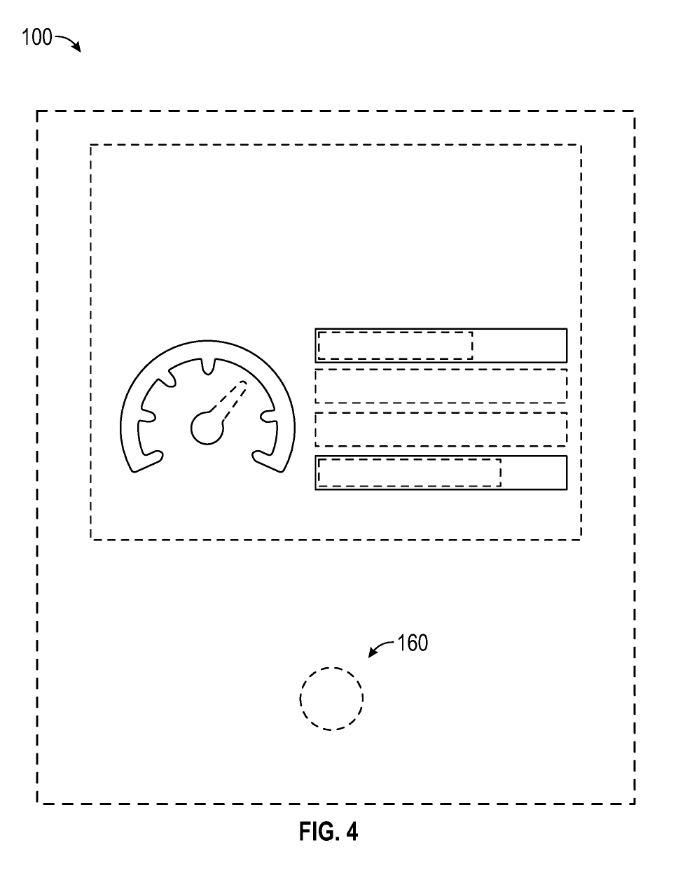

Referring to FIG. 4, a further representation of a consumer display system 100 is illustrated. An optional circular push button interface 160 is depicted below a consumer display system.

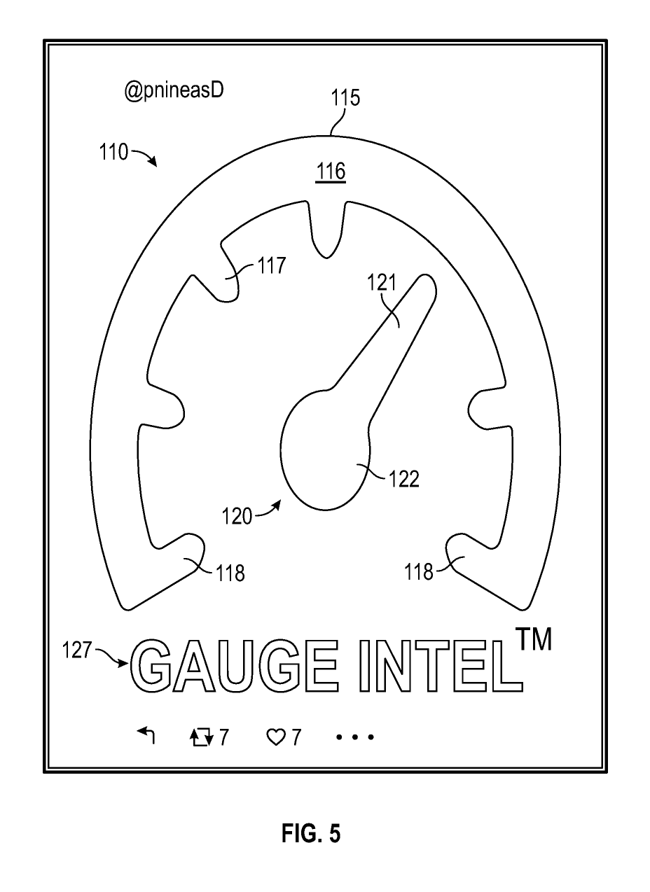

Referring to FIG. 5, a semi-circle or arc display system 110 is depicted and may include an arc element 115, the arc element comprising or defining a void area 116 and sometimes comprising a plurality of inwardly disposed reference notches 117. An arc display system may also comprise one or two end notches 118. A logo area 127 may be found below an arc display system.

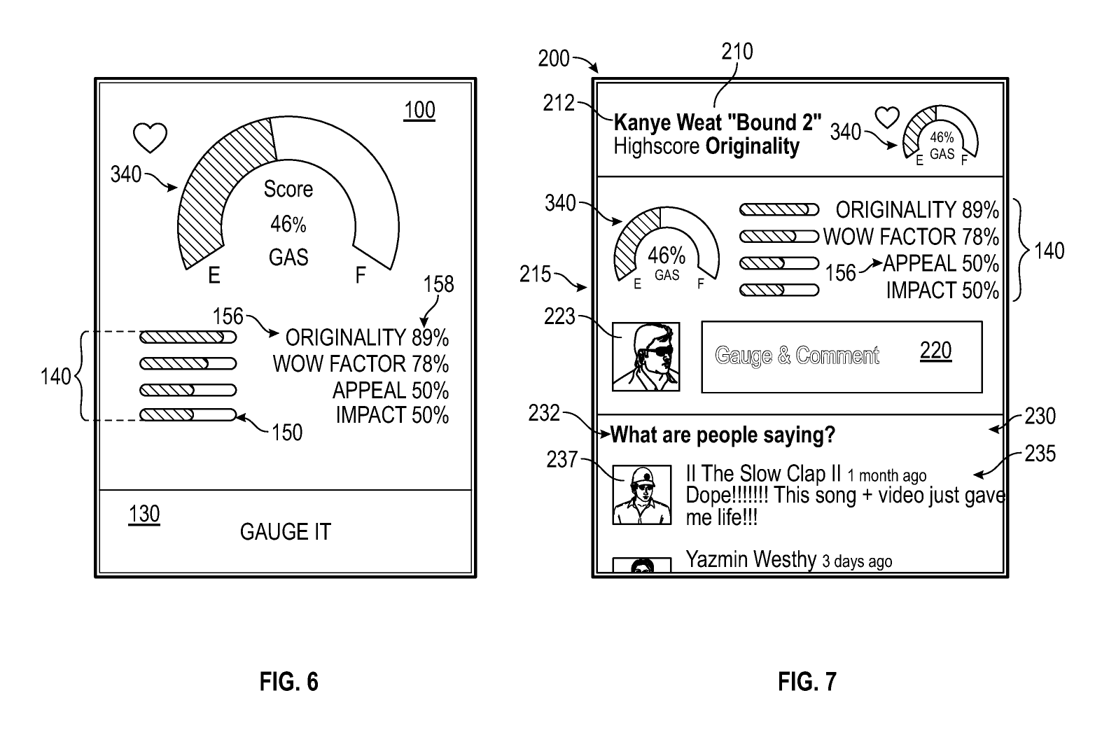

Referring to FIG. 6, a consumer display system 100 is depicted and may include an arc display system or hollow core display system, shown with an “E” for empty and an “F” for full. Below an arc display system, a horizontal matrix 140 may be found. A horizontal matrix, may include a plurality of horizontal display areas 150 with each horizontal display area comprising a data descriptor 156 such as “originality” “wow factor” “appeal” “impact” or others. Each data descriptor 156 may be accompanied by a numeric value 158 to reflect a consumer given score. An activation 130 or “gauge it” interface may be disposed below a horizontal matrix display system 140. An activation interface 130 may provide a push bottom type interface to trigger the entry of consumer data, such as values, data or scores to reflect a consumer's value of a data descriptor 156.

Referring to FIG. 7, a platform display area 200 is depicted and may include a header section 210 comprising content identifier information 212. A header area may further comprise a hollow core arc display system 340. A platform display area may further comprise a mid page area 215 and a mid page area 215 may comprise hollow core arc display system 340 or an arc display 110 disposed adjacent to or near a horizontal matric display system 140. A user icon 223 or a picture of a user may be disposed below a horizontal matric display system 140 and near a gauge and comment 220 interface. A gauge and comment interface 220 may allow a user or consumer to enter data values for data descriptors 156. A platform display area 200 may further include a footer section 230, with the footer section 230 sometimes including descriptor information 232 of third party inputs, an icon 237 or picture of a third party or third party contributor, and third party input 235.

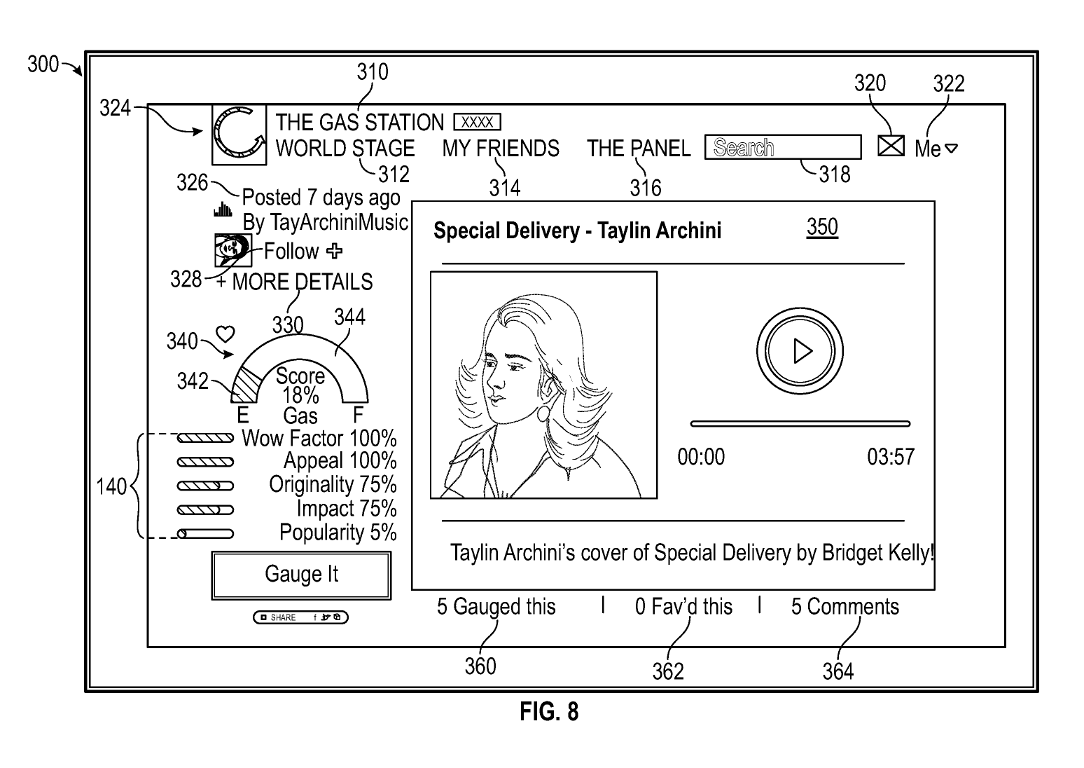

Referring to FIG. 8, a master display system 300 is depicted and may comprise an operator logo area 310, a stage descriptor 312, a my friends descriptor 314, a panel descriptor 316, a search input interface 318, a mail icon 320, a user identifier icon 322, a descriptor 326 of date of posting and identification of poster, a follow interface 328, a more details interface 330 and a hollow core arc display system 340. A hollow core arc display system 340 may be used interchangeable with an arc display system 110. A hollow core arc display system 340, may include an empty void area 344 that may contain a fill area 342, with the volume of the fill area reflecting a score.

A master display system 300 may further comprise a horizontal matrix display system 140. A master display system 300 may further comprise a content display and content control area 350 as well as a descriptor of a number of reviewers 360, a descriptor of a numeric value of favorited ratings 362, and a descriptor of a numeric value of comments 364.

In FIG. 8, the stage descriptor 312 describes the scope or geography of the shown data. In FIG. 8, the stage descriptor 312 is shown as “WORLD STAGE” to indicate that the shown data set or other information in FIG. 8 is on a world wide scale. Other stage descriptors may include, town, state, country and other geographical descriptors.

Moreover, the term “panel Descriptor” may also be used to describe an actual weighted algorithm with the Gauge tool that accounts for certain users Gauge scores to heavier in importance, affecting the score more than other users within the app based on their social media influence.

In FIG. 8, the panel descriptor 316 is shown to be “The Panel.” A stage descriptor may also mean a section of the app/technology called the World Stage that actually disseminates the top reviewed content and displays it within a specific part of the platform ranking the content based on.

Disclosed embodiments also include an Accumulative Arc View Display, shown generally in FIG. 8 wherein there are four specialized labeled categories 140. The Gaugr arc view of a disclosed arc view display differs from conventional displays as it carries a numerical score connected to specific action language (four specialized labeled categories) 140 that accumulates in a real time view for the user. As opposed to being disseminated on the back end away from customer view. This embodiment allows for aggregated data to be available during the most critical time of user engagement.

Disclosed embodiments are sometimes described as “Gaugr” and/or “Gaugr tech” and/or “The Gaugr.”

Gaugr tech mater display specialized categories (four labeled the most relevant information about content) allows more detailed display vs. five stars. As numerical percentages represent detail and potential vs five stars representing a fixed static point of view.

Gaugr tech allows user to control the processing of reviews rather than a company processing information on the back end.

Gaugr tech also eliminates the need for excessive typing of comments which allows for ease of use and the content receiving more data.

The disclosed embodiments overcome shortfalls in the related art by allowing a greater amount of information to be illustrated from user input. In the human psyche “Gauging something” actually precedes the individual “Liking” whatever the object of attention is. If an individual goes to the a shoe store and is viewing a pair of shoes the person first “Gauges” multiple aspects/categories of the shoe before “Liking” it and making the choice to purchase or not.

### Example

1) Will these shoes look good with other articles of clothing i own?

2) Will my friends or significant others like the shoes?

3) Are these shoes cost effect for my budget?

4) All other factors considered, will these shoes simply add to my overall confidence?

After these factors are gauged in the mind, the individual then makes a choice to “Like” the product or not. Much in the same way of this mental functionality of the human thought process The Gauge allows users across the web to engage with content in this same manner. Disseminating the interaction process in two, four interchangeable categories The Gauge offers the user this same process of interaction that already take place in their everyday life.

Once a user enters their respective feelings into the categories of The Gauge an average of these feelings is calculated and produces a percentage of interest, represented by the GAS score level of the gauge attached to the content they just engaged with. This interactive process also leads the user to make more detailed comments as they are now in the fold of detailing information based on the Gauging experience.

These Gauges and comments are then housed, processed, analyzed and disseminated into folds of data that cannot exist via current data analytics tools which are limited by only allowing the user a singular response mechanism. Once stored these folds of data become, in essence, the emotion of the user, as the gauge by its functionality connotes what led the user to making a final decision. Conjuring information that leads a user to a final decision is invaluable to any local companies, content poster, artist, product manufacturer and corporations. As knowing how your consumer feels and what leads them to purchase or not is more valuable than the fact that they actually purchased or not.

The Disclosed Embodiments Include Unique Tools

The web is flooded with content searching for different platforms to be expressed upon. Once users find their destination they are not given many options on how they can engage online. One of the most popular and evolving comment management system in the market is the “Disqus” platform. Yet, even with clients like CNN & Wall Street journal Disqus still admits that the comment management market will continue to evolve and has plenty of room for innovative additions to the way data is housed, disseminated and even displayed. This innovation is what the Gauge Intel “Gauge It” software system will offer. Not being limited to singular responses such as the current Like button functionality and other response devices. “Gauge It” software offers:
A Data analytics tool in “The Gauge” that allows for more in depth opinions to be expressed by users. Interchangeable categories that captures user emotional triggers. And a sliding Gauge scale to highlight the particulars of a user opinion, all with in 1 to 5 seconds.
A Power promotion ability that connects to users social media profiles automatically and blasts out their opinion every time the user gauges something. The Wall Street journal uses WordPress plugins which “Gaugelt” software would be similar to. Although the “Gauge It” free widgets would allow for greater promotion of Wall Street journal content across the web and greater analysis of the comments, along with in depth user ability to disseminate conversations within the blog.
A Commenting system that keeps the conversation relevant for users by keyword stripping and displaying on the top comment feed.
Ability for users to Gauge their peers comments within a discussion not just content itself.

These functionalities are missing and severely needed in the analytics market as companies search innovative yet intrusive ways to find out more about their consumers. Yet these companies are limited to the users not being able to express the depth of their opinions with the limits of current comment managements systems and tools. “Gauge It” software would solve both the issues of user engagement/expression and the analytics ability of companies.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

Items

1. A computer implemented display system, the display system comprising:

a consumer display system to accept and display content ratings entered by a consumer, the consumer display system comprising:

i. an arc display system (110), with the arc display system comprising an arc element 115, the arc element defining a hollow area and further defining a plurality of inwardly disposed reference notches (117) and two end notches (118), the arc display system further comprising a pivoting pointer 120 disposed within the arc display system with the pivoting pointer comprising a pivot section 123 attached to a pointer section 121;

ii. a first horizontal matrix display system (140) comprising a plurality of horizontal display areas (150) with each horizontal display area comprising a filled section (152) and an empty section (154) the volume of the filled section set to reflect a consumer rating, each horizontal display area further including a data descriptor (156) and a numeric value (158) with the numeric value comporting to the consumer rating;

a platform display area (200) comprising:

i. a header section (210) the header section comprising content identifier information (212) and a first hollow core arc display system (340);

ii. a mid page area (215) the mid page area comprising a second hollow core arc display system (340), a second horizontal display matrix display system (140), a user icon (223) and a gauge and comment display and interface (220);

iii. a footer section (230) comprising descriptor information of third party inputs (232), an icon of a third party (237) and the display of third party input (235);

a master display system (300) comprising:

i. an operator logo area (310), a stage descriptor (312) a my friends descriptor (314), a panel descriptor (316) a search input interface (318) a mail icon (320) a user identifier icon (322), a descriptor (326) of date of posting and identification of poster.

Item 2. The computer implemented display system of 1, wherein the master display system further includes a follow interface (328), a more details interface (330) a third hollow core arc display system (340), a third horizontal matrix display system (140), and a content display and control interface (350).

What is claimed is:

1. A computer implemented display system, the display system comprising:
a consumer display system (100) to accept and display content ratings entered by a consumer, the consumer display system comprising:
(i) an arc display system (110), with the arc display system comprising an arc element (115), the arc element defining a hollow area and further defining a plurality of inwardly disposed reference notches (117) and two end notches (118), the arc display system further comprising a pivoting pointer (120) disposed within the arc display system with the pivoting pointer comprising a pivot section (123) attached to a pointer section (121);
(ii) a first horizontal matrix display system (140) comprising a plurality of horizontal display areas (150) with each horizontal display area comprising a filled section (152) and an empty section (154) the volume of the filled section set to reflect a consumer rating, each horizontal display area further including a data descriptor (156) and a numeric value (158) with the numeric value comporting to the consumer rating;
a platform display area (200) comprising:
(i) a header section (210) the header section comprising content identifier information (212) and a first hollow core arc display system (340);
(ii) a mid page area (215) the mid page area comprising a second hollow core arc display system (340), a second horizontal display matrix display system (140), a user icon (223) and a gauge and comment display and interface (220);
(iii) a footer section (230) comprising descriptor information of third party inputs (232), an icon of a third party (237) and the display of third party input (235);
a master display system (300) comprising:
(i) an operator logo area (310), a my friends descriptor (314), a search input interface (318) a mail icon (320) a user identifier icon (322), a descriptor (326) of date of posting and identification of poster.

2. The computer implemented display system of claim 1, wherein the master display system further includes a follow interface (328), a more details interface (330) a third hollow core arc display system (340), a third horizontal matrix display system (140), and a content display and control interface (350).
